(19) United States
(12) Patent Application Publication
(10) Pub. No.: US 2005/0070175 A1
(43) Pub. Date: Mar. 31, 2005

(54) IC socket contact

(76) Inventor: Shinichi Hashimoto, Kanagawa (JP)

Correspondence Address: BARLEY SNYDER, LLC, 1000 WESTLAKES DRIVE, SUITE 275, BERWYN, PA, 19312, US

(21) Appl. No.: 10/953,820

(22) Filed: Sep. 29, 2004

(30) Foreign Application Priority Data
Sep. 29, 2003 (JP) 2003-337857

(51) Int. Cl. H01R 13/40

(52) U.S. Cl. 439/862

(57) ABSTRACT

The present invention provides an IC socket contact in which the elasticity of a resilient arm, the stability within a housing and the flexibility of a terminal section are ensured with minimized inductance. An IC socket contact has a resilient arm that comes into contact with a contact section of an IC package, a mounting section that is fixed to a housing in which the IC package is placed, and a terminal section that is soldered to a substrate on which the housing is placed. The resilient arm and the terminal section are continuous in a vertical direction. The mounting section is bent back 180° to the back side from a connecting wall of an intermediate section between the resilient arm and the terminal section and extends in a vertical direction.

### FIELD OF THE INVENTION

The present invention relates generally to electrical connectors and more particularly to an integrated circuit (IC) socket contact for use in a housing which is mountable on a substrate.

### BACKGROUND

A known IC socket contact is formed of metal and is inserted into a contact receiving area provided in an insulating housing. The housing detachably holds an IC package and is disposed on a circuit substrate. The contact electrically connects the IC package and the circuit substrate (see Japanese Patent Laid-Open No. 2000-113952, U.S. Pat. No. 6,132,222, and Japanese Patent Laid-Open No. 2002-25730, for example).

Such an IC socket contact typically has a resilient arm that includes a contact part with a contact section, a mounting section that is fixed to a socket housing, and a terminal section that includes a solder foot that is soldered to a substrate on which this housing is to be placed. The mounting section is wider than the contact arm and the terminal section, and this IC socket contact is inserted into a contact receiving area provided in an insulating housing and is fixed when the mounting section engages an inner wall of the contact receiving area.

In the contacts for IC sockets proposed in the above-described patent documents, electrical contact is obtained between a contact section provided at the leading end of the contact arm and a contact section provided in the IC package by imparting resiliency to the contact arm and ensuring contact pressure between these contact sections.

The electrical connection of these IC socket contacts to a circuit substrate is obtained by soldering a solder foot provided at the end of the terminal section of the contacts for IC socket to a solder pad provided on the circuit substrate. By imparting flexibility to the terminal section, solder cracks due to a difference in the coefficient of expansion between the housing and the circuit substrate are prevented.

In the IC socket contact disclosed in the above Japanese Patent Laid-Open No. 2000-113952, however, the resiliency of the resilient arm is obtained by a meandering pattern and, therefore, inductance is large, posing the problem that it is impossible to accommodate an increase in the signal transmission speed from the IC package to the circuit substrate.

In the IC socket contact proposed in the above U.S. Pat. No. 6,132,222, the flexibility of the terminal section is improved by reducing the area where the contact part of the contact mounting section engages the mounting section and by making part of the mounting section free. However, the controllability of the position of the contact within the housing decreases accordingly.

In the IC socket contact proposed in the above Japanese Patent Laid-Open No. 2002-25730, a metal plate has a two-forked end, one arm of which is bent back 180° to the end opposite to the two-forked end to be used as a resilient arm. The other arm of which is used as a terminal section. In this case, inductance is large because the portion from the resilient arm to the solder tail section is not linear, posing the problem that it is impossible to cope with an increase in the speed of signal transmission from the IC package to the circuit substrate.

In view of the above-described circumstances, the present invention has as an object, among others, the provision of an IC socket contact in which the position controllability within the housing and the flexibility of the resilient arm and the terminal section are ensured with minimized inductance.

### SUMMARY

An IC socket contact according to the invention has a resilient arm that comes into contact with a contact section of an IC package, a mounting section that is fixed to a housing in which the IC package is placed, and a terminal section that is soldered to a substrate on which the housing is placed. The resilient arm and the terminal section are continuous and the mounting section, is bent back 180° to the back side from a connecting wall of an intermediate section.

### BRIEF DESCRIPTION OF THE DRAWINGS

FIG. 1 is a drawing that shows, in views (a)-(d), a contact of a first embodiment of the invention; and

FIG. 2 is a drawing that shows, in views (a)-(b), a contact of a second embodiment of the invention.

### DETAILED DESCRIPTION OF THE EMBODIMENT(S)

A first embodiment of an IC socket contact according to the invention will be described below.

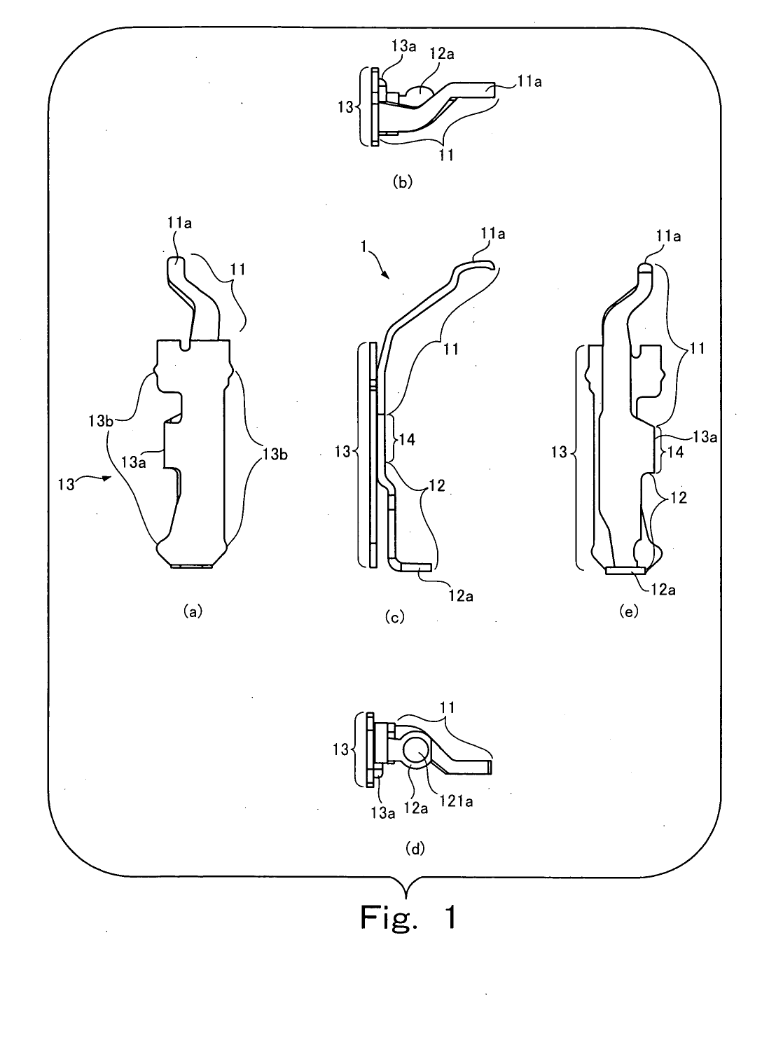

FIG. 1 is a drawing that shows a contact of this embodiment.

A back view of a contact 1 is shown in view (a) of FIG. 1, a top view thereof in view (b), a right side view thereof in view (c), a bottom view thereof in view (d), and a front view thereof in view (e).

The contact 1 shown in FIG. 1 is formed of metal and is inserted into a contact mounting section provided in an insulating housing, which detachably holds an IC package and is disposed on a circuit substrate, and electrically connects the IC package and the circuit substrate.

As shown in view (c) of FIG. 1, the contact 1 has a resilient arm 111 that includes a contact section 11a that comes into contact with an IC package, which is not shown, a terminal section 12 that has a solder foot 12a that is solderable to a circuit substrate, which is not shown, an intermediate section 14 that is located between the resilient arm 11 and the terminal section 12, and a mounting section 13 that is a part bent back 180° to the back side from a connecting wall 13a (see view (a) of FIG. 1) of this intermediate section 14 and extends in a vertical direction. Incidentally, view (d) of FIG. 1 shows a semispherical concavity 121a provided in the solder foot 12a, which is a solder pool to be used in soldering to the circuit substrate. This intermediate section 14 corresponds to the intermediate section between the resilient arm and the terminal section according to the invention.

The mounting section 13 shown in view (a) of FIG. 1 has, at both top and bottom ends thereof, barbs 13b and the contact 1 is fixed to the housing when these barbs 13b are press fit into the contact mounting section.

The resilient arm 11 and the terminal section 12 are connected to the mounting section 13 only by the connecting wall 13a and, therefore, providing flexibility for the resilient arm 11 and the terminal section 12 with respect to the mounting section 13.

The resilient arm 11 and the terminal section 12 are continuous in a vertical direction, that is, the signal path is continuous and, therefore, it is possible to minimize inductance.

Because the mounting section 13 is a part that is bent back 180° to the back side from the connecting wall 13a of the intermediate section 14 between the resilient arm 11 and the terminal section 12 and is substantially independent of the resilient arm 11 and the terminal section 12, it is possible for the mounting section 13 to have a height adapted to the housing without being limited by the resilient arm 11 and the terminal section 12.

As described above, according to the contact 1 of this embodiment, it is possible to stabilize the position of the contact in the housing while ensuring the flexibility of the resilient arm with minimized inductance and without reducing the flexibility of the terminal section.

Next, the second embodiment of an IC socket contact according to the invention will be described.

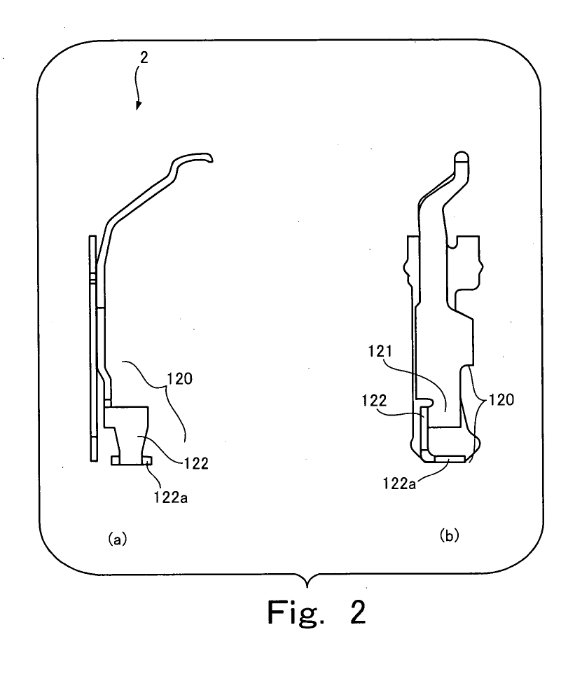

FIG. 2 is a drawing that shows a contact of a second embodiment of the invention.

A right side view of a contact 2 is shown in view (a) of FIG. 2 and a front view thereof in view (b). Because the contact 2 of this embodiment differs from the contact 1 of the first embodiment only in a terminal section 120, only this terminal section 120 will be described below.

The terminal section 120 of the contact 2 has a main wall 121 and a angled wall 122 that includes a solder foot 122a, and the angled wall 122 is bent approximately 90° to the front with respect to the main wall.

Thus, by changing the direction of the end of the terminal section 120 approximately 90°, the range of movement spreads to the right side and the left wide, as well as to the front side and the far side in the drawing of view (a) of FIG. 2. As a result, it is possible to further increase the flexibility of the terminal section and to prevent the occurrence of solder cracks to a greater extent.

In the IC socket contact according to the invention, the portion from the resilient arm to the terminal section is continuous, that is, the signal path is continuous. For this reason, inductance can be minimized. Furthermore, the mounting section of an IC socket contact according to the invention is a part which is bent back 180° to the back side from a connecting wall of an intermediate section between the resilient arm and the terminal section and is formed substantially independently of the resilient arm and the terminal section. Thus, regardless of the resilient arm and the terminal section it is possible for the mounting section to have a size or heights which is adapted to the housing. For this reason, according to an IC socket contact of the invention, it is possible to stabilize the position of the IC socket contact mounted on the housing while ensuring the flexibility of the resilient arm and the terminal section with respect to the mounting section.

The terminal section may have a bent part that is bent approximately 90° to the front side from a connecting wall of an end of the soldered tail.

This enables the flexibility of the terminal section to be further increased and, therefore, the likelihood of solder cracks can be further reduced.

According to an IC socket contact of the invention, it is possible to ensure the resiliency of the resilient arm, the stability of the resilient arm in the housing and the flexibility of the terminal section while minimizing inductance.

1. An IC socket contact comprising:
a resilient arm that comes into contact with a contact section of an IC package;
a terminal section that is solderable to a substrate on which the housing is placed, the terminal section being continuous with the resilient arm;
a connecting wall located at an intermediate section between the resilient arm and terminal section; and,
a mounting section bent back 180° from the connecting wall to a back side of the intermediate section, the mounting section being mountable to a housing in which the IC package is placed.

2. The IC socket contact of claim 1 further comprising barbs extending outward from the mounting section.

3. The IC socket contact of claim 2 further comprising a solder foot located in the terminal section.

4. The IC socket contact of claim 3 wherein the solder foot has a semispherical concavity formed therein.

5. The IC socket contact according to claim 1, wherein the terminal section has an angled wall that is bent approximately 90° from the connecting wall toward a front side.

6. The IC socket contact of claim 5 further comprising barbs extending outward from the mounting section.

7. The IC socket contact of claim 6 further comprising a solder foot located in the terminal section.

8. The IC socket contact of claim 7 wherein the solder foot has a semispherical concavity formed therein.
